(19) United States
(12) Patent Application Publication
(10) Pub. No.: US 2015/0062490 A1
(43) Pub. Date: Mar. 5, 2015

(54) BACKLIGHT UNIT AND LIQUID CRYSTAL DISPLAY DEVICE INCLUDING SAME

(71) Applicant: Jin Hyuk Kwon, Daegu (KR)

(72) Inventor: Jin Hyuk Kwon, Daegu (KR)

(73) Assignee: Research Cooperation Foundation of Yeungnam University, Gyeongsan-si, Gyeongsangbuk-do (KR)

(21) Appl. No.: 14/372,023

(22) PCT Filed: Aug. 8, 2012
(86) PCT No.: PCT/KR2012/006306

§ 371 Date: Nov. 13, 2014

(30) Foreign Application Priority Data
Jan. 13, 2012 (KR) 10-2012-0004232
Aug. 1, 2012 (KR) 10-2012-0084499

(51) Int. Cl. G02F 1/1335; G02F 1/017; F21K 99/00; G02B 3/00; F21V 8/00

(52) U.S. Cl. CPC G02F 1/133621; G02B 3/005; G02B 6/0055; F21K 9/56; G02F 1/133606; G02F 1/133524; G02F 1/133603; G02F 1/01708; G02F 1/133617; G02F 2001/01791
USPC 349/64; 349/62

(57) ABSTRACT

Disclosed is a backlight unit that includes: a light guide plate that guides light, using internal total reflection; a plurality of short wavelength light sources that are disposed on a side of the light guide plate and radiate short wavelength lights into the light guide plate; a three-color light source array that is disposed on the bottom or the top of the light guide plate and includes a plurality of color conversion materials exciting the short wavelength lights from the short wavelength light sources into red or green or blue; and a lenticular lens array sheet that is disposed between the three-color light source array and the liquid crystal panel and refracts the three color lights emitted from the three-color light source array into the subpixels.

### TECHNICAL FIELD

The present invention relates to a backlight unit (BLU) of a liquid crystal display, and more particularly, to a backlight unit capable of improving optical efficiency of a liquid crystal display and a liquid crystal display including the backlight unit.

### BACKGROUND ART

In general, a liquid crystal display is composed of a liquid crystal panel converting various items of electric image information into video information, using a change in transmittance of a liquid crystal due to an applied voltage, and a backlight unit supplying light to the liquid crystal panel. A plurality of liquid crystal pixels in the liquid crystal panel is composed of R, G, and B subpixels that make red (R), green (G), and blue (B) images, respectively, and R, G, and B color filters are disposed on the fronts of the subpixels.

In LCDs of the related art, most of the power of white light from a backlight unit is lost by a polarizing sheet and a color filter on the front and rear of liquid crystal pixels, and the aperture ratio of liquid crystal pixels and only light of about 5 to 10% comes outside the liquid crystal panel, so there is a problem in that the optical energy efficiency of the LCDs is considerably low. Accordingly, it is an important matter to improve the optical energy efficiency of the LCDs, for strengthening competitiveness of the LCDs and saving energy. In particular, the color filter causes a large amount of loss of power of the LCDs by making the most loss of light, because its transmittance of light is only about 30%.

For this reason, an FSC (Field Sequential Color) technology is one of the technologies that are being developed to increase the optical energy efficiency of the LCDs. The technology, which has been made to remove the color filter having much of the loss of optical energy, uses three of R, G, and B LEDs as the light sources of backlight, separates a screen image signal into three of R, G, and B image signals, sequentially and quickly spreads the R-image signal, the G-image signal, and the B-image signal to a liquid crystal panel while an R-LED, a G-LED, and a B-LED are turned on, respectively to enable an observer to feel a color image.

Although the FSC LCD technology has been considerably progressed by many researches, because it does not need subpixels and color filters and its light transmittance efficiency is improved, there is a need of about six times the speed of a circuit adjusting images in comparison to the existing common LCDs and there are problems such as flickering and color break-up of moving images, so it has not been made practicable yet.

Taira et al. have attempted to implement an LCD without a color filter by separating a white light source into red, green, and blue, using a diffraction grating, and by sending them into red, green, and blue color filters, using a lenticular lens. His technology, which is a technology basically for removing the color filters in a liquid crystal panel, needs an angle correction device having a complicated structure due to a problem with the traveling angle of light separated by a diffraction grating and is difficult to manufacture because its structure is too complicated.

The applicant(s) of the present invention has made applications of “Liquid crystal display without color filter” (Registration No. 10-0993695, US2009/0262280) and “Liquid crystal display” (10-1033071), which increase efficiency of liquid crystal. Those patents have direct type structures and there is a problem in that the thickness of the backlight unit increases and a diffusion layer is required in the liquid crystal panels.

The present invention has been made to improve the light transmittance of an LCD using new optical structure and principle for solving the problems of Taira, as described above, and the main problems in “Liquid crystal display” (10-1033071).

### DISCLOSURE

### Technical Problem

The present invention has been made in an effort to solve the problems and an object of the present invention is to provide a backlight unit of a liquid crystal display which can improve light transmittance efficiency by using a light guide plate or a direct type backlight, which are easily manufactured with a simple structure, and by arranging a lenticular lens array or a color-matching sheet with RGB subpixels or RGB color filters, between a three-color light source array and a liquid crystal panel so that RGB lights are matched and travel into the RGB subpixels and the RGB color filters, and which can improve optical energy efficiency by having optical design and arrangement according to obtained color-matching conditions.

### Technical Solution

According to the present invention for achieving the objects, there is provided a backlight unit that is disposed under a liquid crystal panel including a plurality of subpixels corresponding to three color lights, respectively, and radiates three color of red, green, and blue lights. The backlight unit includes: a light guide plate that guides light, using internal total reflection; a plurality of short wavelength light sources that are disposed on a side of the light guide plate and emit short wavelength lights into the light guide plate; a three-color light source array that is disposed on the bottom or the top of the light guide plate and includes a plurality of color conversion materials exciting the short wavelength lights from the short wavelength light sources into red or green or blue; and a lenticular lens array sheet that is disposed between the three-color light source array and the liquid crystal panel and focuses the three color lights radiated from the three-color light source array into the subpixels.

Further, the present invention provides a backlight unit that is disposed under a liquid crystal panel including a plurality of subpixels corresponding to three color lights, respectively, and emits three color of red, green, and blue lights. The backlight unit includes: a transparent substrate; a straight three-color self-light emitting source array that is disposed on the bottom or the top of the transparent substrate, emits red, green, and blue, and is sequentially arranged; and a lenticular lens array that is disposed between three-color self-light emitting source array and the liquid crystal panel and focuses the three color lights emitted from the three-color self-light emitting source array into the subpixels.

Further, the present invention provides a backlight unit that is disposed under a liquid crystal panel including a plurality of subpixels corresponding to three color lights, respectively, and emits three color of red, green, and blue lights. The backlight unit includes: a light guide plate that guides light, using internal total reflection, and has a scattering pattern that scatters light with regular intervals, on the bottom; a plurality of short wavelength light sources that are disposed on a side of the light guide plate and emitting short wavelength lights into the light guide plate; and a color-matching sheet that is disposed between the light guide plate and the liquid crystal panel, converts light radiated from the light guide plate into three color lights, and refracts the three color lights into the subpixels.

Further, the present invention provides a backlight unit that is disposed under a liquid crystal panel including a plurality of subpixels corresponding to three color lights, respectively, and emits three color of red, green, and blue lights. The backlight unit includes: a diffusion plate that diffuses light; a plurality of short wavelength light sources that are disposed under the diffusion plate and radiating short wavelength lights to the diffusion plate; and a color-matching sheet that is disposed between the diffusion plate and the liquid crystal panel, converts light radiated from the diffusion plate into three color lights, and refracts the three color lights into the subpixels.

### Advantageous Effects

The backlight unit according to the present invention and the liquid crystal display including the backlight unit have the following effects.

First, it is possible to improve light transmission efficiency of a liquid crystal liquid display by using a backlight unit that spreads red, green, and blue lights directly onto subpixels and color filters corresponding to red, green, and blue, respectively, using a three-color light source array corresponding to three of red, green, and blue light sources.

Second, since the lenticular lens array sheet and the color-matching sheet which have simple structures are used, they can be easily manufactured.

Third, since the R, G, B three color lights are produced by using R, G, B phosphors or R, G, B quantum dots which receive UV LED light and emit R, G, B light as the three-color light source array, it is possible to maintain a simple structure and achieve high efficiency.

Fourth, since R and G color lights are produced by using a blue (B) LED and phosphors or quantum dots, respectively, emitting red (R) and green (G) by receiving light from the blue (B) LED, and blue color light is produced by scattering a blue light through a scattering pattern, it is possible to maintain a simple structure and achieve high efficiency.

Fifth, since a light source array such as R, G, B OLEDs or R, G, B quantum dots are used as the three-color light source array, instead of LEDs, it is possible to simplify the structure of the light sources and keep all of advantages of a liquid crystal display and a light source array, such that it is possible to achieve high efficiency and image quality.

Sixth, since R, G, B lights are supplied to the R, G, B subpixels, it is possible to remove R, G, B color filters. Further, it may be possible to keep the color filters in order to reduce color crosstalk between adjacent pixels and stabilize the image quality.

### DESCRIPTION OF DRAWINGS

FIG. 1 is a view illustrating a first embodiment of the present invention.

FIG. 2 is a perspective view of FIG. 1.

FIG. 3 is a view illustrating an application example of the first embodiment of the present invention.

FIG. 4 is a view illustrating a color conversion material and a three-color light source array.

FIG. 5 is a view illustrating a second embodiment of the present invention using an OLED or a quantum dot (QD) as a three-color light source.

FIG. 6 is an application example of FIG. 5.

FIG. 7 is a view illustrating a third embodiment of the present invention.

FIG. 8 is a view illustrating a fourth embodiment of the present invention.

FIG. 9 is a perspective view illustrating color-matching sheets illustrated in FIGS. 7 and 8.

### BEST MODE

Hereinafter, exemplary embodiments of the present invention will be described with reference to accompanying drawings. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

A backlight unit according to the present invention and a liquid crystal display using the backlight unit will be described in detail with reference to drawings.

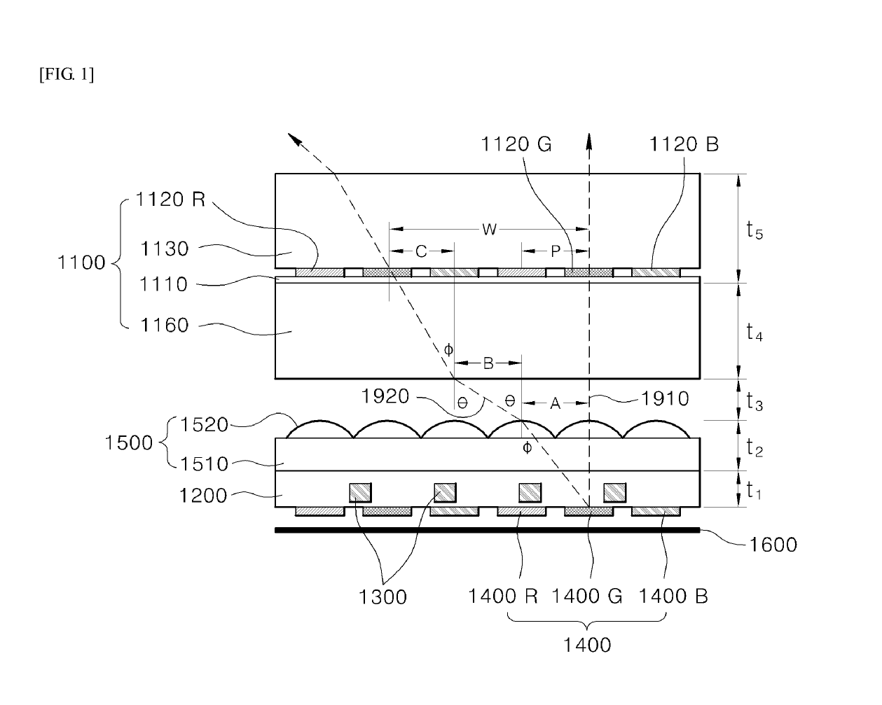

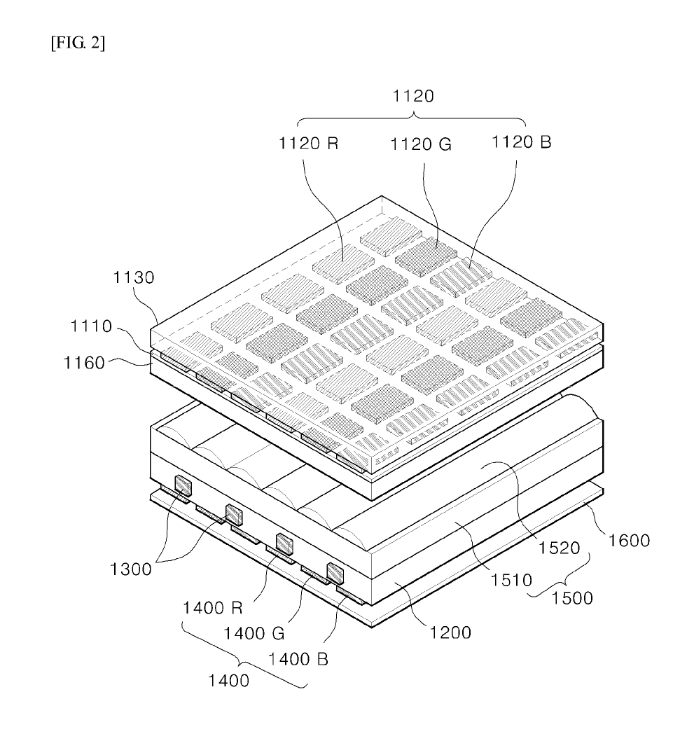

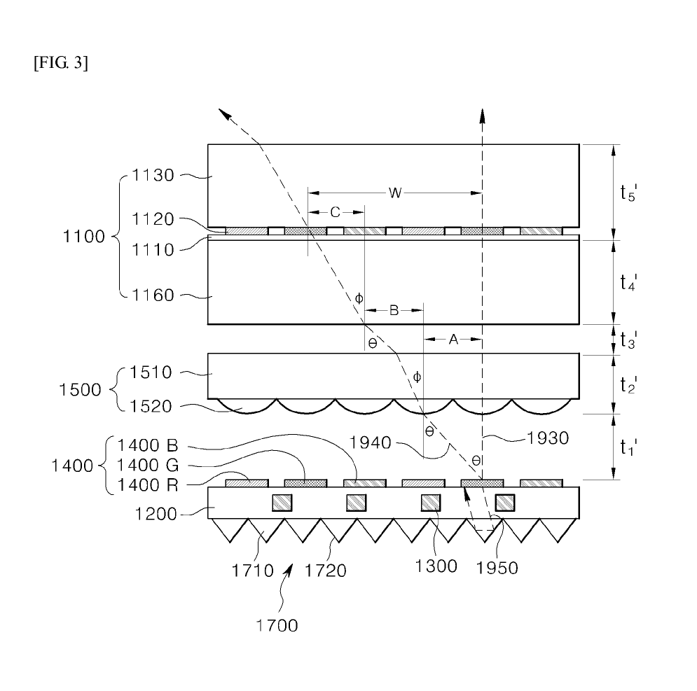

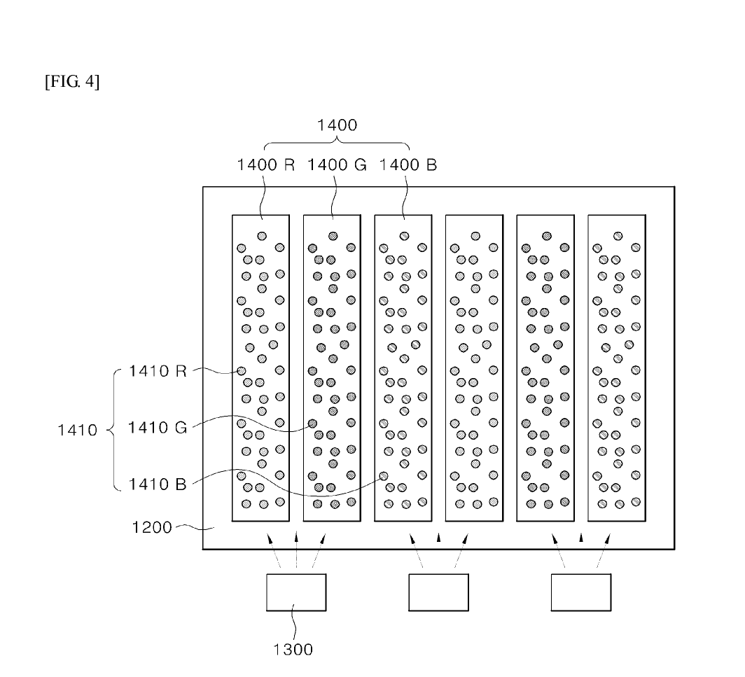

FIG. 1 is a view illustrating a first embodiment of the present invention, FIG. 2 is a perspective view of FIG. 1, FIG. 3 is a view illustrating an application example of the first embodiment of the present invention, and FIG. 4 is a view illustrating a color conversion material and a three-color light source array.

Referring to FIG. 1, a backlight unit is composed of a liquid crystal panel 1100 and a backlight under the liquid crystal panel 1100, the backlight is composed of a light guide plate 1200, blue LEDs, as short wavelength light sources 1300, disposed on a side of the light guide plate 1200 and radiating light into the light guide plate 1200, a three-color light source array 1400 including RGB color conversion materials 1410 (1410R, 1410G, 1410B) sequentially disposed in parallel under the light guide plate 1200, and a white light reflection layer 1600.

The liquid crystal panel 1100 is composed of subpixels 1110 (1110R, 1110G, 1110B) or color filters 1120 (1120R, 1120G, 1120B), a front glass substrate 1130, and a rear glass substrate 1160, and a lenticular lens array sheet 1500 to be described below is composed of a lens transparent substrate 1510 and lenticular lenses 1520 disposed in series on the lens transparent substrate 1510.

The color conversion materials 1410 (1410R, 1410G, 1410B) are composed of RGB phosphors, RGB quantum dots (QD), and a white scattering material, of combinations of them. When a blue LED is used as the short wavelength light source 1300, the color conversion materials 1410 (1410R, 1410G, 1410B) sequentially disposed in parallel may be a red phosphor, a green phosphor, and a white phosphor, or may be composed of a red quantum dot, a green quantum dot, and a white quantum scatterer. The blue can be obtained simply from scattering of the white scatterer.

The lenticular lens array 1500 is disposed between the light guide plate 1200 and the liquid crystal panel 1100 and may be integrally formed on the light guide plate 1200.

The three-color light source array 1400 including the RGB color conversion materials 1410 (1410R, 1410G, 1410B) sequentially disposed in parallel, the lenticular lens sheet 1520 of the lenticular lens array sheet 1500, and the RGB subpixels 1110 or the RGB color filters 1120 of the liquid crystal panel 1100 should be arranged along the same colors.

A blue light (for example, 470 nm of wavelength) from the blue LED that is the short wavelength light source 1300 generates RGB lights by hitting against the RGB color conversion materials 1410 (1410R, 1410G, 1410B) sequentially disposed in parallel on a straight line on the bottom of the light guide plate 1200 while traveling through the light guide plate 1200 by total reflection.

The light traveling downward in the red, green, and blue lights generated by the blue light emitted from the blue LED and traveling into the color conversion materials 1410 (1410R, 1410G, 1410B) reflects from the white reflection layer 1600 under the light guide plate 1200 and fully travels up toward the liquid crystal panel 1100. There is little optical difference, if the blue LED is replaced by a blue LD (Laser Diode).

The white reflection layer 1600 may be a separate sheet or may be coated integrally on the bottom of the light guide plate 1200. The red, green, and blue lights are sent into the red, green, and blue subpixels 1110R, 1110G, 1110B or the RGB color filters 1120, respectively, in the liquid crystal panel 1100 by the lenticular lens array sheet 1500 at the upper portion, thereby increasing transmittance.

In FIG. 1, the light from any one color conversion material (for example, 1410G) is uniformly diffused in all directions, the light 1910 vertically traveling upward is collected by the lenticular lenses 1520 vertically arranged and travels into the lower liquid crystal pixel 1110G or the color filter 1120G vertically disposed and having the same color, but the light 1920 diffused in another direction becomes a lost light that does not contribute to improving the transmittance or travels into the other subpixels 1110R, 1110B and color filters 1120R, 1120B which have different colors, thereby decreasing the image quality. In order to guide the light 1920 diffused in another direction into the lower liquid crystal pixel 1110G or the color filter 1120G which has the same color, the thickness t₁ of the light guide plate 1200, the thickness t₂ of the lenticular lens array sheet 1500, the vertical gap t₃ between the liquid crystal panel 1110 and the backlight unit, and the thickness t₄ of the rear glass substrate 1160 of the liquid crystal panel 1100 should be set to satisfy a color-matching condition.

A horizontal displacement A generated when the light 1920 coming out of any color conversion material (for example, 1410G) at an angle passes through the light guide plate 1200 and the lenticular lens array sheet 1500, a horizontal displacement B generated when the light passes through the vertical gap t₃ between the liquid crystal panel 1100 and the backlight unit, and a horizontal displacement C generated when the light passes through the rear glass substrate 1160 of the liquid crystal panel 1100 are given as follows,

A=(t₁+t₂)tan Φ

B=t₃ tan θ

C=t₄ tan Φ

where Snell's law of sin θ=n sin Φ (n is a refraction ratio) is applied. The color-matching condition is that the sum W of A, B, and C should be three times the period P of the subpixels 1110 or the color filters 1120 at the point where the light 1920 coming out at an angle reaches the lower liquid crystal pixel 1110G or the color filter 1120G.

That is,

W=A+B+C=mP (m=a multiple of three) (color-matching condition 1)

Or

(t₁+t₂+t₄)tan Φ+t₃ tan θ=mP (m=a multiple of three)

when the above mathematical relationships are satisfied, the light 1920 coming out at an angle also travels into the lower liquid crystal pixel 1110G or the color filter 1120G which has the same color (for example, G), so it contributes to improving the light transmittance.

The method of satisfying the color-matching condition can be achieved by adjusting the thickness t₁ of the light guide plate 1200, the thickness t₂ of the lenticular lens array sheet 1500, the vertical gap t₃ between the liquid crystal panel 1110 and the backlight unit, and the thickness t₄ of the rear glass substrate 1160 of the liquid crystal panel 1100 to coincide with the color-matching condition. In particular, once the thicknesses of the light guide plate 1200, the lenticular lens array sheet 1500, and the rear glass substrate 1160 of the liquid crystal panel 1100 are determined, it is difficult to change them, so the vertical gap t₃ between the liquid crystal panel 1110 and the backlight unit can be set as follows to satisfy the color-matching condition, when the liquid crystal panel 1100 and the backlight unit are combined.

$${t}_{3} = \frac{mP - ( {t}_{1} + {t}_{2} + {t}_{4} ) tan θ}{tan θ}$$

As a detailed example, for a Full HD LCD of 47 inches, the color-matching condition is satisfied by setting t₃=0.99 mm, using m=3, P=0.18 mm, t₁=1 mm, t₂=0.2 mm, and t₄=0.9 mm.

FIG. 2 is a perspective view of FIG. 1, blue LEDs that are the short wavelength light sources 1300 are disposed on a side of the light guide plate 1200, a three-color light source array 1400 (1400R, 1400G, 1400B) is sequentially disposed on the bottom of the light guide plate 1200, and the lenticular lens array sheet 1500 is disposed on the top of the light guide plate 1200. The liquid crystal panel 1100 is disposed over the backlight unit composed of the light guide plate 1200 and the lenticular lens array sheet 1500. Polarizing films attached on the outer sides of the front glass substrate 1130 and the rear glass substrate 1160 of the liquid crystal panel 1100 are not illustrated in the figure. The short wavelength light sources 1300 may be disposed on both left and right sides of the light guide plate 1200.

In FIGS. 1, 2, and 4, although the three-color light source array 1400 (1400R, 1400G, 1400B) is disposed on the bottom of the light guide plate 1200, the three-color light source array 1400 (1400R, 1400G, 1400B) may be disposed on the top of the light guide plate 1200.

FIG. 3 is a view illustrating such an application example. Referring to FIG. 3, the three-color light source array 1400 (1400R, 1400G, 1400B) is disposed on the top of the light guide plate 1200 and a plurality of blue LEDs that are short wavelength light sources 1300 are disposed on a side of the light guide plate 1200. When the lights from the blue LEDs hit against the red, green, and blue light change materials 1410 (1410R, 1410G, 1410B), red, green, and blue lights are emitted in several directions.

The color-matching condition in FIG. 3 is as follows.

A=t_{1′} tan θ

B=t_{2′} tan Φ+t_{3′} tan θ

C=t_{4′} tan Φ

In the color-matching condition, the displacement W of an inclined light of the lower liquid crystal pixel 1110 is given as follows.

W=A+B+C=mP (m=a multiple of three) (color-matching condition 2)

The color-matching condition 2 can be expressed as follows.

(t_{4′}+t_{2′})tan Φ+(t_{1′}+t_{3′})tan θ=mP (m=a multiple of three)

The light 1930 vertically emitted toward to the liquid crystal panel 1100 from any one color conversion material (for example, 1410G) travels into the lower liquid crystal pixel 1110G or the color filter 1120G which have the same color by the lenticular lens 1520, thereby having high transmittance. Further, the light 1940 emitted upward at an angle is refracted on the surfaces of the lenticular lens 1520 and the liquid crystal panel 1100 arranged in accordance with the color-matching condition and also travels into the lower liquid crystal pixel 1110G or the color filter 1120G which has the same color, thereby contributing to increasing light transmittance.

In order to prevent that about 50% of the lights emitted from the RGB color conversion materials 1410 (1410R, 1410G, 1410B) travels downward and causes a loss of light and deterioration of image quality, a right-angled prism array 1700 is disposed on the bottom of the light guide plate 1200. The right-angled prism array 1700 is composed of a plurality of right-angled prisms 1710 on the bottom of the light guide plate 1200 and a reflection layer 1720 selectively coated on the bottoms of the right-angled prisms 1710. The light 1950 emitted downward reflects twice from the right-angled prism array 1700, returns to the initial position, and travels into the lower liquid crystal pixel 1110G of the same color or the color filter 1120G, thereby contributing to improving light transmittance.

Although the same as the structure of FIG. 1 or FIG. 3, the blue LEDs may be replaced by near ultraviolet LEDs (for example, wavelength of 405 nm). In this case, the RGB color conversion materials 1410 (1410R, 1410G, 1410B) may be sequentially arranged in accordance with the colors of RGB phosphors or RGB quantum dots, without a white scatterer. The optical structure or the color-matching condition is the same as those in FIG. 1 or FIG. 3.

FIG. 4 illustrates a more detailed structure of the three-color light source array 1400 (1400R, 1400G, 1400B) illustrated in FIG. 1 or FIG. 3. In general, since the lights from the short wavelength light sources 1300 on the side decrease in while traveling through the light guide plate 1200, for uniformity of the red, green, and blue lights emitted from the three-color light source array 1400 (1400R, 1400G, 1400B), RGB phosphors are disposed in a fine pattern, the pattern density of the RGB color conversion materials 1410 (1410R, 1410G, 1410B) is increased in the area close to the short wavelength light sources 1300, and the pattern density of the RGB color conversion materials 1410 (1410R, 1410G, 1410B) is increased or the pattern size of the RGB color conversion materials 1410 (1410R, 1410G, 1410B) is gradually increased in the area far away from the short wavelength light sources 1300, thereby obtaining uniform fluorescence.

### MODE FOR INVENTION

Hereinafter, other embodiments of the present invention will be described with reference to the accompanying drawings.

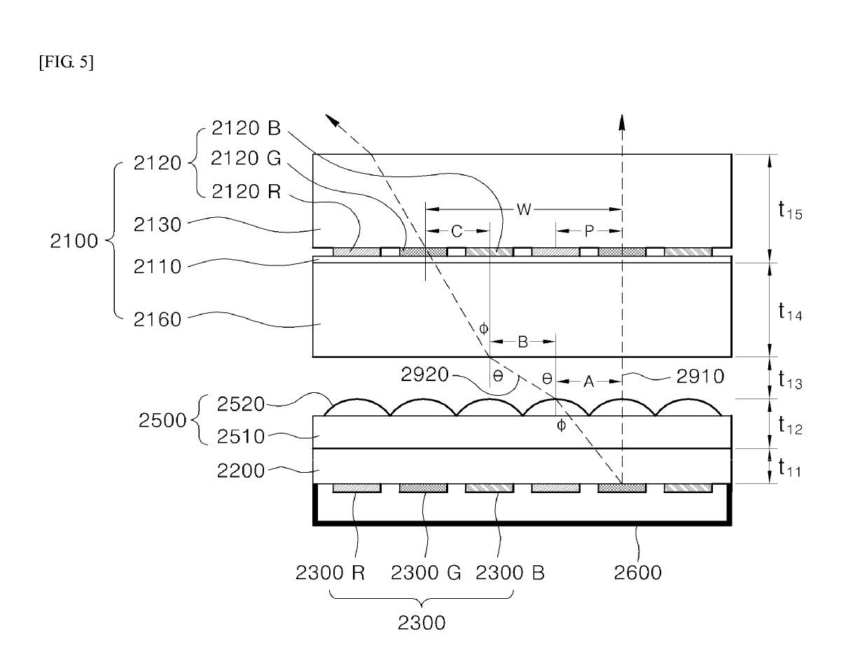

FIG. 5 illustrates a second embodiment applied from the first embodiment of the present invention. Referring to FIG. 5, a backlight unit under a liquid crystal panel 2100 is composed of a lenticular lens array sheet 2500, a transparent substrate 2200, a three-color self-light emitting source array 2300 or a three-color quantum array.

In FIG. 5, RGB OLEDs or RGB quantum dots for the three-color self-light emitting source array 2300 are excited by a current applied from electrodes on the top and the bottom and emit red, green, and blue lights.

An encapsulation 2600 blocking water vapor or oxygen is required, when the RGB OLEDs are used for the three-color self-light emitting source array 2300. Three color lights from the RGB OLEDs travels into RGB subpixels 2110 or RGB color filters 2120, respectively, in the liquid crystal panel 2100 by lenticular lenses 2520, thereby increasing transmittance.

In FIG. 5, similarly, it is possible to satisfy the color-matching condition described with reference to FIG. 1 and improve light transmittance by adjusting the thickness t₁₁ of the transparent substrate 2200, the thickness t₁₂ of the lenticular lens array sheet 2500, the vertical gap t₁₃ between the liquid crystal panel 2100 and the backlight unit, and the thickness t₁₄ of a rear glass substrate 2160 of the liquid crystal panel 2100.

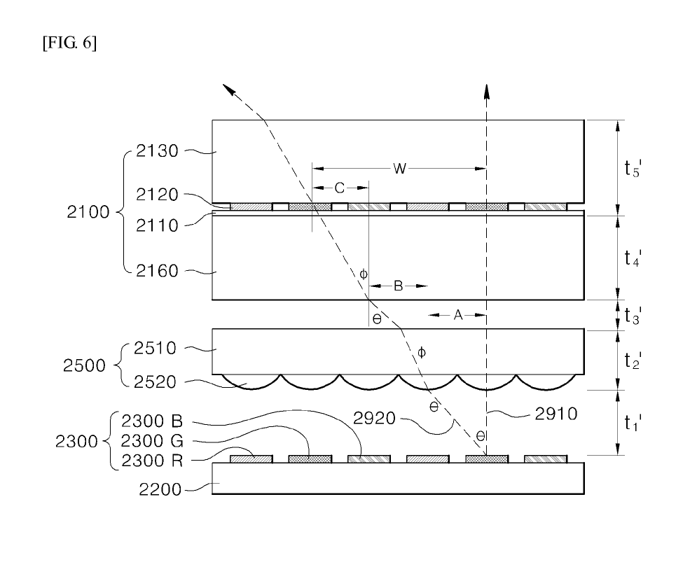

FIG. 6 is an application example of the present invention of FIG. 5. The difference from FIG. 5 is that the three-color self-light emitting source array 2300 is disposed on a substrate and the lenticular lens array sheet 2500 is disposed between the liquid crystal panel 2100 and the three-color self-light emitting source array 2300, but the optical principle is the same as that in FIG. 5. The structure of FIG. 6 is the same as the application example of the first embodiment illustrated in FIG. 3, except that the three-color light source array 1400 (1400R, 1400G, 1400B) is replaced by the three-color self-light emitting source array 2300, so the color-matching condition is applied in the same way as the color-matching condition 2.

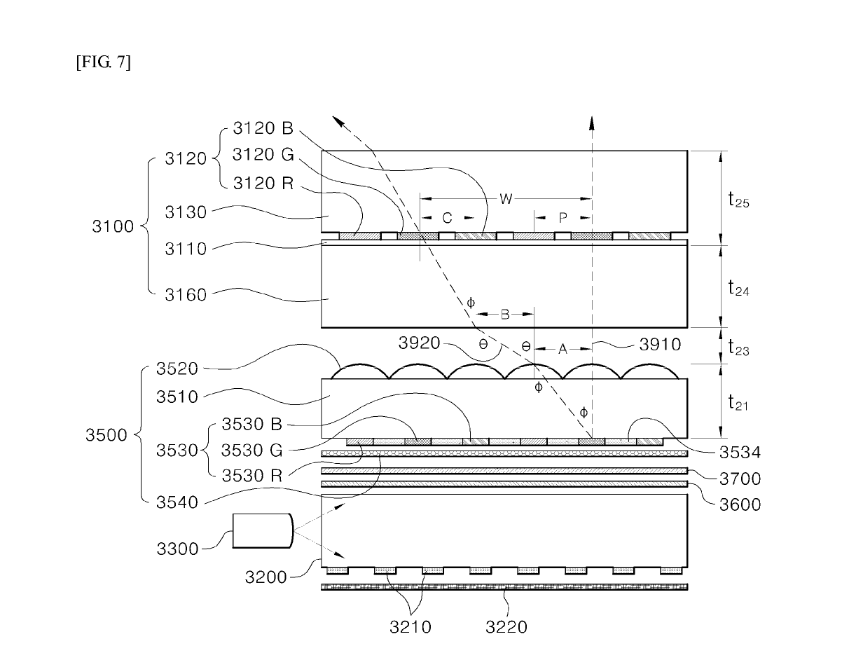

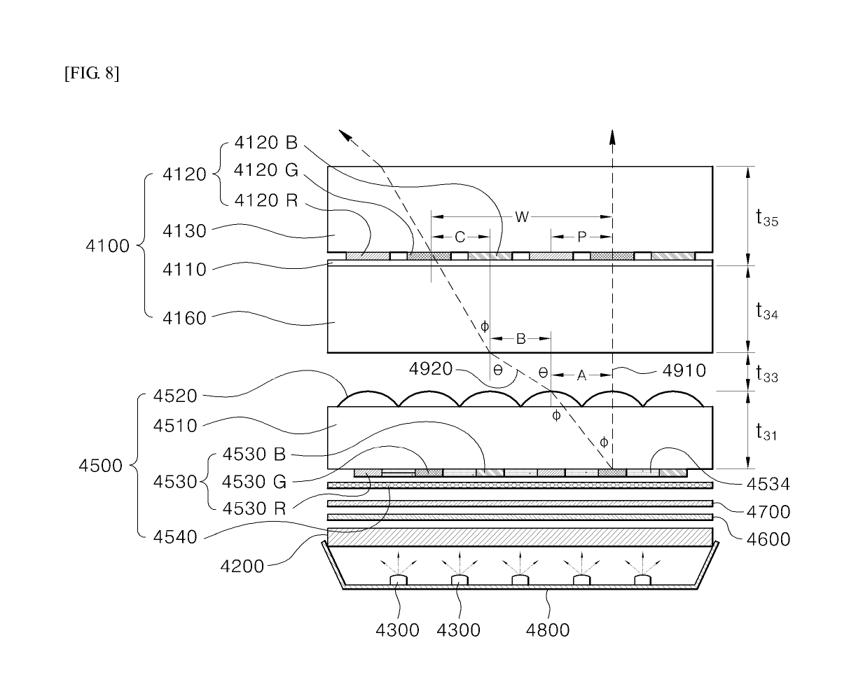

FIGS. 7 and 8 illustrate a third embodiment and a fourth embodiment of the present invention.

FIG. 7 illustrates a structure in which a color-matching sheet 3500 is disposed between a backlight unit having a light guide plate 3200 and a plurality of short wavelength light sources 3300, and a liquid crystal panel 3100. The short wavelength light sources 3300 for backlight are blue LEDs or ultraviolet LEDs.

The blue lights from the blue LEDs, which are the short wavelength light sources 3300, totally reflect in the light guide plate 3200 and then are diffused by a diffusion pattern 3210 under the light guide plate 3200 or reflected from a reflection sheet 3220 under the light guide plate 3200, such that their illuminance is made more uniform and the viewing angle is adjusted by a diffusion sheet 3600 or a light-concentrating sheet 3700, and then the lights travel into the color-matching sheet 3500. The structure of the light-concentrating sheet 3700 usually has the type of a prism sheet having the structure of a prism array or the type of a micro lens array sheet having a micro lens array.

FIG. 8 illustrates the structure of a fourth embodiment applied from the third embodiment illustrated in FIG. 7, in which a color-matching sheet 4500 is disposed between a liquid crystal panel 4100 and a direct type backlight having short wavelength light sources 4300, without the light guide plate 3200.

The short wavelength light sources 4300 are blue LEDs or ultraviolet LEDs. The blue lights from the blue LEDs that are the short wavelength light sources 4300 travel into the color-matching sheet 4500, after the illuminance is made more uniform and the viewing angle is adjusted by the diffusion plate 4200, the diffusion sheet 4600, and the light-concentrating sheet 4700.

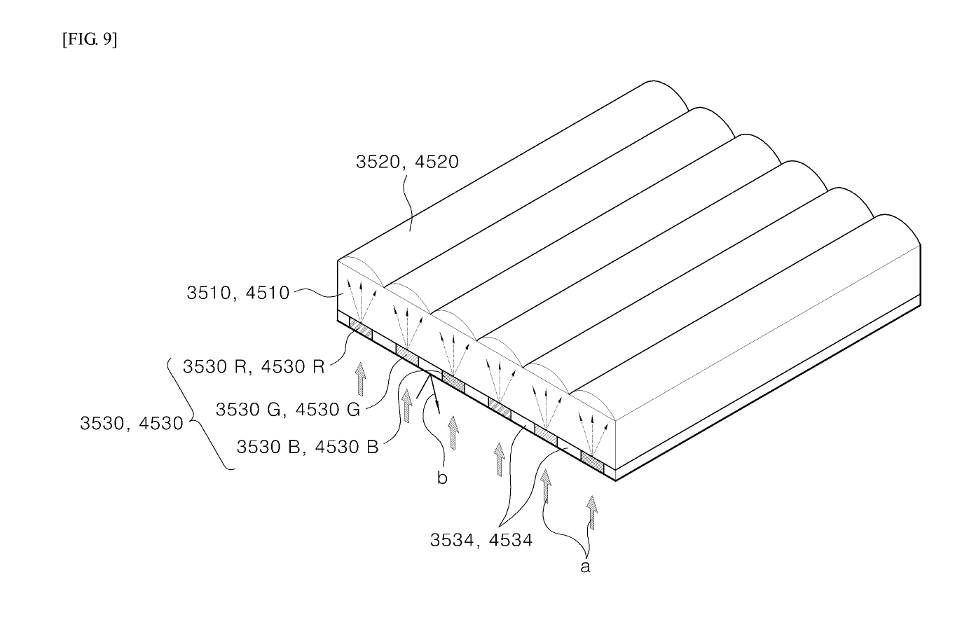

FIG. 9 illustrates the detailed structure and the optical principle of the color-matching sheets 3500 and 4500 used in the third embodiment and the fourth embodiment. The color-matching sheets 3500 and 4500 are composed of transparent substrates 3510 and 4510, lenticular lens arrays 3520 and 4520, and three-color fluorescent material arrays 3530 and 4530, respectively, and may additionally include reflection color filters 3540 and 4540.

In the color-matching sheets 3500 and 4500, the lenticular lens arrays 3520 and 4520 are disposed on the transparent substrates 3510 and 4510, the straight three-color fluorescent material arrays 3530 and 4530 are disposed with the same gaps as the lenticular lens arrays 3520 and 4520 on the bottom of the transparent substrates 3510 and 4510.

The three-color fluorescent material arrays 3530 and 4530 are composed of a plurality of fluorescent materials 3530 (3530R, 3530G, 3530B) exciting the short wavelength lights from the short wavelength light sources 14300 into red, or green, or blue, and the reflection color filters 3540 and 4540 filtering the light traveling into the three-color fluorescent materials arrays 3530 and 4530 may be additionally provided under the three-color fluorescent material arrays 3530 and 4530.

Reflection layers 3534 and 4534 reflecting the light traveling into the transparent substrates 3510 and 4510 are disposed between the fluorescent materials 3530 (3530R, 3530G, 3530B) of the three-color fluorescent material arrays 3530 and 4530.

The three-color fluorescent material arrays 3530 and 4530 are arranged with the same colors as the color filters 3210 and 4120 of the liquid crystal panels 3100 and 4100 in the color-matching sheets 3500 and 4500, and the lenticular lens arrays 3520 and 4520 are arranged in the same period and sequence as the subpixels 3110 and 4110 or the color filters 3120 and 4120.

The principle of the color-matching sheets 3500 and 4500 contributing to improving transmittance of the liquid crystal panels 3100 and 4100 is as follows. When the blue lights from the blue LEDs that are the short wavelength light sources 3300 and 4300 are made uniform by the light guide plate 3200, or the diffusion plate 3200 and the diffusion sheet 3600 and 4600, and the light-concentrating sheets 3700 and 4700, and sent upward into the color-matching sheets 3500 and 4500, the three-color fluorescent material arrays 3530 and 4530 emit red, green, and blue in the arrangement order by the blue lights.

Since the lights traveling into the color-matching sheets 3500 and 4500 are blue lights, the blue fluorescent material 3532b in the three-color fluorescent material arrays 3530 and 4530 may be a white scatterer simply for scattering or may be left transparent in this case. The produced red, green, and blue lights are concentrated by the lenticular lenses of the lenticular lens array 3530 and 4520, respectively, and travel into the red, green, and blue color filters 3120 and 4120 in the liquid crystal panels 3100 and 4100, such that the light transmittance of the liquid crystal panels 3100 and 4100 is increased. When ultraviolet LEDs are used as light sources, red, green, and blue fluorescent materials are used for the three-color fluorescent material arrays 3530 and 4530.

When the relationship equations of the thicknesses t₂₁,t₃₁ of the color-matching sheets 3500 and 4500, the gaps t₂₃,t₃₃ between the color-matching sheets 3500 and 4500 and the liquid crystal panels 3100 and 4100, and the thicknesses t₂₄,t₃₄ of the rear glass substrates 3160 and 4160 of the liquid crystal panels 3100 and 4100, and an incident angle θ, and a refraction angle Φ, satisfy the following equations,

W=A+B+C=uP

or,

(t₂₁+t₂₄)tan Φ+t₂₃ tan θ=uP (u=a multiple of three) (color-matching condition 3)

the highest light transmittance is achieved,
where,

A=t₂₁ tan Φ

B=t₂₃ tan θ

C=t₂₄ tan Φ

sin θ=n sin Φ_{Snell's law} sin θ=n sin Φ is satisfied and n is the refraction ratio of the rear glass substrates 3160 and 4160 and the transparent substrates 3510 and 4510.

In the color-matching condition 3, the thicknesses t₂₁ of the color-matching sheets 3500 and 4500, the gaps t₂₃ between the color-matching sheets 3500 and 4500 and the liquid crystal panels 3100 and 4100, and the thicknesses t₂₄ of the rear glass substrates 3160 and 4160 of the liquid crystal panels 3100 and 4100 are expressed on the basis of the third embodiment, but the color-matching condition 4 of the fourth embodiment is also the same as the color-matching condition of the third embodiment, so the detailed description is not provided.

The red, green, and blue fluorescent lights from the three-color fluorescent material arrays 3530 and 4530 uniformly travel up and down, so it is possible to further improve the light transmittance by additionally disposing the refraction color filters 3540 and 4540, which transmit the blue light passes and reflect the red and green lights, close to the bottoms of the color-matching sheets 3500 and 4500. The reflection color filter 3540 and 4540 may be integrally combined with the color-matching sheets 3500 and 4500.

Some of the blue lights traveling into the color-matching sheet 3500 and 4500 reflect from the reflection layers 3534 and 4534, and the reflecting lights are recycled by reflecting again from the light guide plate 3200 or the reflection sheets 3220 and 4800 under the diffusion plate 4200, and then travel back into the three-color fluorescent material arrays 3530 and 4530. A phosphor, a quantum dot, and a white scattering bead may be used for the fluorescent materials of the three-color fluorescent material arrays 3530 and 4530.

Accordingly, it is possible to improve light transmission efficiency of a liquid crystal liquid display by using a backlight unit that spreads red, green, and blue lights directly onto subpixels or color filters corresponding to red, green, and blue, respectively, using a three-color light source array corresponding to three of red, green, and blue light sources.

Although the present invention has been described with reference to the exemplary embodiments illustrated in the drawings, those are only examples and may be changed and modified into other equivalent exemplary embodiments from the present invention by those skilled in the art. Therefore, the technical protective scope of the present invention should be determined by the scope described in claims.

### INDUSTRIAL APPLICABILITY

The present invention can be used for the backlight unit (BLU) of liquid crystal displays (LCD).

1. A backlight unit that is disposed under a liquid crystal panel including a plurality of subpixels corresponding to three color lights, respectively, and emits three color of red, green, and blue lights, the backlight unit comprising: a light guide plate that guides light, using internal total reflection;
a plurality of short wavelength light sources that are disposed on a side of the light guide plate and emit short wavelength lights into the light guide plate;
a three-color light source array that is disposed on the bottom or the top of the light guide plate and includes a plurality of color conversion materials converting the short wavelength lights from the short wavelength light sources into red or green or blue lights; and a lenticular lens array sheet that is disposed between the three-color light source array and the liquid crystal panel and refracts the three color lights emitted from the three-color light source array into the red, green, blue subpixels, respectively.

2. The backlight unit of claim 1, wherein the three-color light source array is formed straight, includes color conversion materials corresponding to red, green, and blue, respectively, and is arranged with the same spacings as the lenticular lens array sheet and the red, green, and blue subpixels.

3. The backlight unit of claim 1, wherein a white reflection layer is disposed at a predetermined distance under or integrally coated on the bottom of the three-color light source array including the color conversion materials.

4. The backlight unit of claim 1, wherein the color conversion materials is one selected from a phosphor, a quantum dot, a white scatterer, an electroluminescence material, and a photoluminescence material, or a combination of them.

5. The backlight unit of claim 1, wherein the short wavelength light sources are blue LEDs or ultraviolet LEDs.

6. The backlight unit of claim 1, wherein the short wavelength light sources are blue LDs (Laser Diode) or ultraviolet LDs.

7. The backlight unit of claim 1, wherein the three-color light source array is disposed on the top of the light guide plate.

8. The backlight unit of claim 1, the backlight unit further comprising a plurality of right-angled prisms on the bottom of the light guide plate and a right-angled prism array having a reflection layer selectively coated on the bottoms of the right-angled prisms.

9. The backlight unit of claim 1, wherein the lenticular lens array sheet is integrated with any one of the light guide plate or the liquid crystal panel.

10. A backlight unit that is disposed under a liquid crystal panel including a plurality of subpixels corresponding to three color lights, respectively, and radiates three color of red, green, and blue lights, the backlight unit comprising: a transparent substrate;
a straight three-color self-light emitting source array that is disposed on the bottom or the top of the transparent substrate, emits red, green, and blue, and is sequentially arranged; and
a lenticular lens array that is disposed between the three-color self-light emitting source array and the liquid crystal panel and refracts the three color lights emitted from the three-color self-light emitting source array into the subpixels.

11. The backlight unit of claim 10, wherein the three-color self-light emitting source array has a straight shape and red, green, and blue are sequentially arranged in parallel in the same spacing as lenticular lenses of the lenticular lens array sheet and the subpixels.

12. The backlight unit of claim 10, wherein the three-color self-light emitting source array is one selected from red, green, and blue OLEDs, red, green, and blue quantum dots, and red, green, and blue electroluminances, or a combination of them.

13. The backlight unit of claim 1, wherein the lenticular lens array sheet includes a lens transparent substrate transmitting light upward and a plurality of lenticular lenses disposed in the same period as the subpixels of the liquid crystal panel, on the lens transparent substrate, and refracting light passing through the lens transparent substrate, to the subpixels.

14. The backlight unit of claim 10, wherein the lenticular lens array sheet is integrated with any one of the transparent substrate or the liquid crystal panel.

15-16. (canceled)

17. A backlight unit that is disposed under a liquid crystal panel including a plurality of subpixels corresponding to three color lights, respectively, and emits three color of red, green, and blue lights, the backlight unit comprising: a light guide plate that guides light, using internal total reflection, and has a scattering pattern that diffuses light, on the bottom;
a plurality of short wavelength light sources that are disposed on a side of the light guide plate and emitting short wavelength lights into the light guide plate; and a color-matching sheet that is disposed between the light guide plate and the liquid crystal panel, converts light emitted from the light guide plate into three color lights, and refracts the three color lights into the subpixels.

18. (canceled)

19. The backlight unit of claim 17, wherein the color-matching sheet includes:
a transparent substrate;
a lenticular lens array sequentially arranged in the same period as the subpixels, on the top of the transparent substrate; and
three-color fluorescent material arrays disposed under the transparent substrate and including a plurality of fluorescent materials exciting the short wavelength lights into red or green or blue.

20-26. (canceled)

27. The backlight unit of claim 10, wherein the lenticular lens array sheet includes a lens transparent substrate transmitting light upward and a plurality of lenticular lenses disposed in the same period as the subpixels of the liquid crystal panel, on the lens transparent substrate, and refracting light passing through the lens transparent substrate, to the subpixels.
